(19) United States
(12) Patent Application Publication
(10) Pub. No.: US 2006/0161287 A1
(43) Pub. Date: Jul. 20, 2006

(54) Rapid prototyping and manufacturing of photocured objects using LCD panel as programmably variable photomask

(76) Inventor: Steven F. Simonis, Powell, OH (US)

Correspondence Address: KREMBLAS, FOSTER, PHILLIPS & POLLICK, 7632 SLATE RIDGE BOULEVARD, REYNOLDSBURG, OH, 43068, US

(21) Appl. No.: 11/036,247

(22) Filed: Jan. 14, 2005

(51) Int. Cl. G06F 19/00

(52) U.S. Cl. 700/120; 700/119

(57) ABSTRACT

An improved rapid prototyping and manufacturing system. The improvement is at least two liquid crystal display panels interposed between a UV light source and a descendible platform to form a variably programmable photomask. A computer is connected to each display panel and includes stored, sliced data sets representing parallel, cross-sectional patterns of an object at spaced increments. The platform is lowered, preferably in stepwise increments, and selected patterns are sequentially displayed on each LCD panel as bitmaps generated from the sliced data sets to provide a series of photomasks, each photomask representing a parallel cross-section of the object at spaced increments. Preferably, an entirely opaque display pattern is displayed on the each panel during the time intervals of platform motion and one of the display panels is switched from an entirely opaque display pattern to a pattern representing a parallel, cross-section at least one liquid crystal phase cycle before the other panel is switched.

### BACKGROUND OF THE INVENTION

1. Field of the Invention

This invention relates generally to systems for rapid prototyping and manufacturing of objects using photocurable polymer and more particularly to such systems having a considerably reduced cost of both the equipment and the materials consumed in the fabrication of the objects.

2. Description of the Related Art

The prior art has developed an extensive variety of rapid prototyping and manufacturing systems for the computer aided manufacture of three-dimensional objects such as models of mechanical component parts. Most of these systems begin with the creation of a three-dimensional CAD data model of the object to be fabricated. The CAD software then translates the data that defines the three-dimensional object into sliced data sets representing parallel, cross-sections of the object which are spaced at a desired increment. In some systems, a perforated, elevator platform is immersed in a vat of a photocurable polymer and is lowered in successive, short, stepwise increments of a fraction of a millimeter. As the platform is lowered, a thin layer of photocurable polymer liquid flows over the top of the platform or the uppermost solidified surface of the partially fabricated object. At each incremental level, the platform is held stationery and the CAD data is used to control a light source, such as laser or other radiant energy source, to selectively cure and solidify the photopolymer liquid in a cross-sectional pattern. Through numerous repetitions of this sequence, successive, thin, cross-sectional layers are built up, layer by layer, to form a solid, integral object on the platform. For some systems, the solid object is then additionally cured.

One of the most common systems is stereo lithography. This system uses a laser beam directed by a computer controlled mirror to progressively photocure each of the series of cross-sectional layers. Although stereo lithography produces high resolution, quality objects, it is both expensive and slow. A stereo lithography system typically costs over $120,000 and each vat of photocurable polymer costs on the order of $40,000. The system is slow because the laser beam is directed to only one small spot at any instant of time and yet must spend sufficient time to fully cure the photocurable polymer at each spot in a two-dimensional grid array of contiguous spots in order to fully cure the entire cross-sectional layer. Consequently, each layer can require two to four minutes to be cured. It is not unusual for six to twelve hours to be required for fabricating an object and large objects can require several days.

Solid ground curing is another system of this general type. This system also uses an elevator platform immersed in a photocurable polymer and successive layers are cured and built up on the platform. However, instead of steering a laser over each layer, light from a UV light source is directed through a photomask onto each successive liquid polymer layer to cure and solidify the layer. Although this system allows the use of considerably less expensive UV curable polymers and avoids the time delay that is characteristic of the stereo lithography system, it requires the time and materials for the preparation of one or more photomasks. While an object having an identical cross-sectional size and shape for all layers requires only a single photomask, most objects have a more complicated morphology and therefore require numerous photomasks. Consequently, this system requires an extensive set up time for the preparation of the required photomasks. Furthermore, the photomasks are each a separate physical entity and, as the successive layers are progressively cured, the photomask must be physically changed whenever the next cured layer will be different from the preceding layer. Such photomask exchange is usually accomplished either by manually removing one photomask and inserting the next or by scrolling a strip of photomasks through the system. Therefore, except for the most simple objects, solid ground curing requires considerable setup time for preparing the series of physical photomasks and requires operating time for exchanging or indexing the physical photomasks during processing. The equipment is also expensive, though not as expensive as stereo lithography equipment, but it also requires the cost of the physical photomask material.

It is therefore an object and feature of the invention to provide an apparatus and method for the rapid solidification and manufacture of objects that requires considerably less time for set up and preparation because there is no requirement for the fabrication of physical photomasks.

It is another object and feature of the invention to provide a rapid solidification and manufacturing apparatus and method that require considerably less time for the fabrication of an object because the use of laser beam curing of the photopolymer is avoided.

Another object and feature of the invention is to provide a rapid solidification and manufacturing apparatus and method that not only reduce preparation and fabrication time but also permit use of relatively inexpensive, UV curable photopolymers.

Yet another object and feature of the invention is to provide such an apparatus and method that is inexpensive because it does not require specialized equipment and materials for fabricating photomasks and therefore is practical and inexpensive for smaller companies and professional offices, such as individual dentist's offices, hospital surgery rooms or even for the homes of consumers.

### BRIEF SUMMARY OF THE INVENTION

The invention is an improved rapid prototyping and manufacturing system having a radiant energy source mounted for directing radiant energy toward an elevator platform descendible in a vat of photopolymer liquid under computer control for curing a layer of the photopolymer upon which the radiant energy is incident. The improvement is at least two liquid crystal display panels interposed between the radiant energy source and the platform to form a variably programmable photomask. A computer is connected to each display panel for controlling the display panel cells. The computer has stored, sliced data sets representing parallel, cross-sectional patterns of an object at spaced increments.

The invention is practiced by lowering the platform at a controlled velocity algorithm as done in the prior art, preferably in stepwise increments. Selected patterns are sequentially displayed on each LCD panel as bitmaps generated from the sliced data sets to provide a series of photomasks, each photomask representing a parallel cross-section of the object at spaced increments. Preferably, an entirely opaque display pattern is displayed on the each panel during the time intervals of platform motion and one of the display panels is switched from an entirely opaque display pattern to a pattern representing a parallel, cross-section at least one liquid crystal phase cycle before the other panel is switched.

### BRIEF DESCRIPTION OF THE SEVERAL VIEWS OF THE DRAWINGS

FIG. 1 is a diagram illustrating an embodiment of the invention.

FIG. 2 is a flow chart illustrating the method of practicing the invention.

In describing the preferred embodiment of the invention which is illustrated in the drawings, specific terminology will be resorted to for the sake of clarity. However, it is not intended that the invention be limited to the specific term so selected and it is to be understood that each specific term includes all technical equivalents which operate in a similar manner to accomplish a similar purpose.

### DETAILED DESCRIPTION OF THE INVENTION

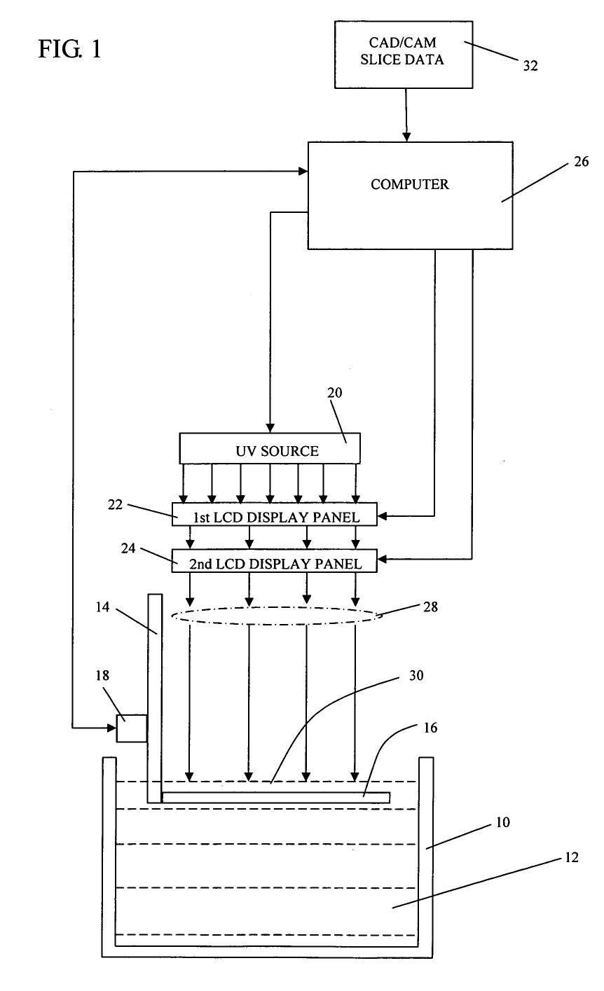

FIG. 1 illustrates the preferred embodiment of the invention. A vat 10 contains a liquid photopolymer 12. An elevator 14 mounted as a slidable carriage has a descendible platform 16 which is raised and lowered by a prime mover 18. The prime mover 18 may, for example, be a stepper motor driving the elevator through a worm gear and screw transmission. The above described components, as used in embodiments of the invention, are common to several rapid prototyping and manufacturing systems known in the prior art and therefore are not described in more detail.

Mounted above the platform 16 and arranged in generally vertical alignment are a UV light source 20 below which is mounted a primary liquid crystal display (LCD) panel 22 and a secondary LCD panel 24. An LCD panel is a two-dimensional grid array of contiguous liquid crystal pixels that is controlled by an electronic, digital data processing device and in the preferred embodiment of the invention by a computer 26. Ordinarily each pixel is independently addressable by an attached computer so it can be independently controlled. The pixel patterns or image can be varied electronically and dynamically by the computer during practice of the invention. The type of LCD panels used with the invention are, for example, polymer suspended liquid crystal devices and have pixels that can be alternatively switched by a control current to a transparent phase state and to an opaque phase state. This type of LCD panel has been commonly used for back lit computer displays and computer display projectors.

Although the basic unit of the LCD panel is the pixel, a block of multiple pixels can form a cell and be controlled as a unit. Preferably, however, for maximum resolution, each cell is a single pixel that is independently controlled. Additionally, LCD panels are not perfect and therefore some light transmission will occur in the opaque state and some light absorption and reflection will occur in the transparent state. Consequently, the terms opaque state and transparent state are used to mean the relatively more opaque state and the relatively more transparent state.

A lens 28 may optionally be used to focus the light transmitted through the transparent pixels of the LCD panels 22 and 24 onto the thin layer 30 of liquid photocurable liquid polymer lying on top of the platform 16 or on top of the previously cured polymer layer of the object being fabricated to form an image of the transparent pattern displayed on each LCD panel. A lens can enhance resolution and can be used to resize an image pattern.

The computer 26 is connected to the elevator prime mover 18 to control the motion and vertical position of the elevator platform 16, and is also connected to control the UV light source 20 and the LCD display panels 22 and 24. The connection to the elevator can include a position sensing signal to provide feedback for control of the elevator platform depth. The computer can be a special purpose computer or controller or preferably a general purpose computer. It should also be apparent to those skilled in the art that the computer control and data processing functions used in practicing the invention, including CAD operations to be described, can be distributed among multiple computers or consolidated in a single computer. The computer has the storage, input and output devices known to those skilled in the art.

As with prior art systems, the process begins with the creation of a three-dimensional CAD data model of the object to be fabricated and the CAD software then translates the data that defines the surface contours of the three-dimensional object into sliced data sets, each set representing a parallel, cross-section or slice of the object. These data slices are spaced at a desired increment, typically on the order of 0.001″ and usually within the range of 300 to 1200 parallel, data slice planes per inch and the distance between the slices represents the cured layer thickness. They can be more closely spaced for greater resolution. This slice data is stored on the computer and, if a computer different from the CAD computer is used to control the object fabrication, the CAD slice data 32, is transferred to the computer 26.

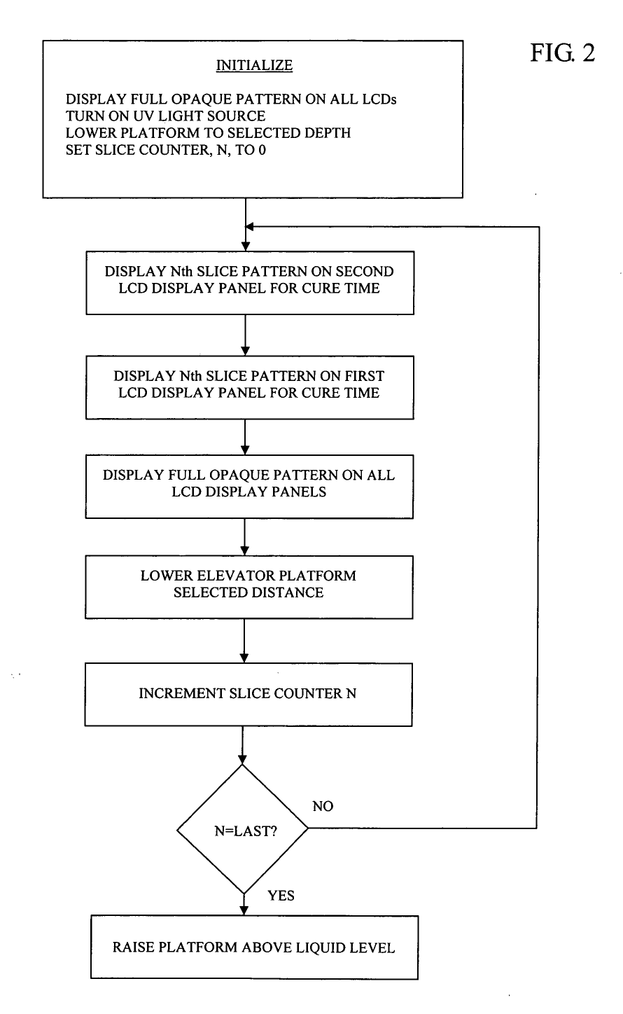

After the vat 10 is filled with a UV curable polymer, the apparatus illustrated in FIG. 1 is initialized, as illustrated in FIG. 2, by turning on the UV light source 20, lowering the top surface of the platform 16 to a depth below the top surface of the photocurable polymer 12 to provide a liquid depth equal to the desired layer thickness and, for example, setting a counter for counting slices or layers to 0, all of which may be done as conventionally practiced in prior art techniques. For the invention, initialization also includes displaying a fully opaque pattern on the LCD panels 22 and 24; that is all pixels are switched to an opaque or black state.

Generally, a series of selected cross-sectional patterns are then sequentially displayed on the LCD panels to provide an electronically generated photomask and the elevator platform is sequentially lowered is stepwise increments. Of course, it is common for some of the cross-sectional patterns to be repetitions of previous patterns, especially when adjacent cross-sectional slices of the object are identically configured, oriented and positioned. Preferably, an entirely opaque pattern is displayed on the LCD panels between each of the time intervals when cross-sectional patterns are displayed, which is ordinarily whenever the elevator is being moved. Preferably, after the elevator has become stationary and the LCD panels are switched from entirely opaque state to the next cross-sectional pattern, the next cross-sectional pattern is displayed on one LCD panel before being displayed on the other panel rather than simply switching the displayed patterns simultaneously.

The time intervals when the LCD panels are entirely opaque are interposed between the time intervals of cross-section pattern display to accomplish several purposes. This allows more precise control of the exposure time during which the photocurable polymer is cured and solidified and avoids image blurring and partial curing in the blurred areas that can arise from vibration during motion of the elevator. This also prevents any blending or “light bleeding” in transitions from one photomask pattern to another which can result in partially or improperly cured polymer representing photomask areas that have different states in consecutive photomasks.

There are advantages to using two or more tiers or layers of LCD panels aligned along the light path but displaying identical patterns. Multiple LCD panels assist in collimating the light from the light source. The collimation improves the resolution or sharpness of the boundary between the areas that are illuminated and those that are not. If light is reflected from the surface of the polymer upwardly back toward the light source the multiple tier LCD panels limit the reflection of this light back down onto a dark portion of the photocurable polymer. Additionally, light may pass through a nominally opaque area or pixel on an LCD display as a result of a pixel defect or less than 100% opacity. In that event, the second LCD display will block such bleed-through in nominally opaque areas.

Although the two LCD panel photomasks can be switched simultaneously to the next consecutive cross-section pattern, there are advantages to switching one and, after the first is switched, switching the second. In the preferred embodiment, the second LCD panel 24 is switched from its entirely opaque state to display of a cross-section pattern and after one LCD phase change cycle, typically 1/60 second, the first LCD panel 22 is similarly switched. Although this time delay for the phase change of the LCD tiers is only a small fraction of a second, it avoids the leakage of light through areas of the LCD panel during the transitional or partial phase state change. Cure rate timing begins when the first LCD panel 22 has switched phases.

Although some of these problems could be reduced or eliminated by turning off the UV light source at selected times, such as whenever the elevator is moved and when the LCD panels are being switched, this is not preferred because it would introduce additional problems.

There are parameters and choices that are preferably applied to the practice of the invention.

The UV light source can be a bulb or florescent type, or a grid array of them. Another desirable source is a grid array of UV radiating light emitting diodes, the latter being mountable closer to the uppermost LCD panel. Known UV sources can be used and should provide light distributed with relatively uniform intensity across the LCD displays.

The LCD panels may be relatively small, on the order of 1.5 to 3 inch rectangles or may be larger, such as 12 inch panels. For 3 inch panels, the panels may, for example, be spaced ¼ inch apart with the UV light source mounted, for example, 1-3 inches above the uppermost LCD panel. Larger panels may have proportionally larger spacings. More than two LCD panels may be used in the manner described above to further improve collimation of the light incident upon the thin layer of photocurable polymer. However, additional panels would add further cost.

Although a variety of UV settable polymers are available, the dental industry uses a UV settable polymer that is a hard ceramic and would be suitable for practicing the present invention. Such polymers are used for fabricating a filling for a tooth cavity or a tooth crown. The present invention can be used for fabricating such dental objects and the dentist could do it in his office while the patient waits. Similarly, bone replacements can also be made by surgeons during surgery. The user would scan the tooth, bone or other structure, use a CAD/CAM program to generate the layers or slices and then generate the needed object on equipment embodying the present invention.

Although the preferred velocity algorithm for lowering the elevator platform is in conventional stepwise increments with exposure while the platform is stationery, the platform could be lowered at a continuous velocity instead of in increments and the display patterns varied along the way. However this is believed not preferred because resolution will not be as good and cure times will not be as well controlled.

From the above it can be seen that the principal advantage of the present invention is that it provides a very low cost alternative to known rapid prototyping and manufacturing systems. This is accomplished by eliminating expensive laser devices and their controls, eliminating the need for physical photomasks and using mature and therefore relatively inexpensive LCD technology to provide an electronically variable photomask. It is expected that equipment embodying the present invention can be profitably sold at a cost comparable to that of a laser printer, on the order of $1000 to $1500, thus enabling small companies and hobbyists to fabricate objects much like desktop publishing has allowed the low cost manufacture of relatively sophisticated publications at low cost.

The fact that the photomasks are stored as data in the present invention allows rapid, programmatic modification or editing of them via the computer for correcting errors and making modifications to the fabricated object. Also, this allows photomasks to be reused by displaying them on the LCD displays multiple time thereby eliminating the need for generating multiple, identical physical photomasks for non-consecutive display. Vertical resolution along the Z-axis is limited only by the resolution of the elevator and resolution in the X-axis and Y-axis are limited only by the resolution of the LCD panels. After a CAD/CAM system has generated the slice data, a relatively rough, low resolution object can be prototyped using fewer than all slices and instead using every Nth slice and lowering the elevator platform n times its high resolution lowering distance.

Furthermore, because the photomasks for the present invention reside in a computer storage device and these are very inexpensive, it is not necessary for a user to make a tradeoff between high vertical resolution accompanied by the high cost of a large number of physical photomasks and low vertical resolution in order to reduce the photomask cost.

While certain preferred embodiments of the present invention have been disclosed in detail, it is to be understood that various modifications may be adopted without departing from the spirit of the invention or scope of the following claims.

1. An improved rapid prototyping and manufacturing apparatus having a radiant energy source mounted for directing radiant energy toward an elevator platform descendible in a vat under computer control for curing a layer of a photopolymer liquid contained in the vat upon which the radiant energy is incident, wherein the improvement comprises:
(a) at least two liquid crystal display panels interposed between the radiant energy source and the platform to form a variably programmable photomask, the panels each having a two dimensional grid array of contiguous liquid crystal cells independently capable of being alternatively switched by a control current to a transparent phase state and to an opaque phase state; and
(b) a computer connected to the display panels for controlling the display panel cells, the computer including a storage device for storing software computer control instructions and a plurality of sliced data sets representing parallel, cross-sectional patterns of an object at spaced increments.

2. An apparatus in accordance with claim 1 wherein the display panels are spaced apart.

3. An apparatus in accordance with claim 2 wherein the display panels are connected to the computer for applying the identical data sets to the panels.

4. An apparatus in accordance with claim 1 or 2 or 3 wherein the radiant energy source is a source of ultraviolet light.

5. An improved method for fabricating a solid object by directing radiant energy toward an elevator platform descendible in immersion in a vat of photocurable polymer liquid for curing a layer of the polymer liquid upon which the radiant energy is incident, wherein the improvement comprises:
(a) lowering the platform according to a controlled velocity algorithm; and
(b) sequentially displaying selected patterns on at least two liquid crystal display panels interposed between the radiant energy source and the platform, the panels having a two dimensional grid array of contiguous liquid crystal cells independently capable of being alternatively switched by a control current to a transparent phase state and to an opaque phase state, the sequential patterns being generated from a plurality of sliced data sets representing parallel, cross-sections of the object at spaced increments.

6. A method in accordance with claim 5 wherein the velocity algorithm comprises lowering the platform in successive, stepwise increments of alternating motion time intervals and interposed stationery time intervals and wherein an entirely opaque display pattern is displayed on at least one of the panels during motion time intervals.

7. A method in accordance with claim 6 wherein an entirely opaque display pattern is displayed on both panels during platform motion time intervals.

8. A method in accordance with claim 7 wherein the radiant energy is ultraviolet light.

9. A method in accordance with claim 8 wherein one of the display panels is switched from an entirely opaque display pattern to a pattern representing a parallel, cross-section at least one liquid crystal phase cycle before the other display panel is switched.
